(19) United States
(12) Patent Application Publication
(10) Pub. No.: US 2010/0117391 A1
(43) Pub. Date: May 13, 2010

(54) TRANSPORTING APPARATUS

(75) Inventors: MASANAO MURATA, Ise-shi (JP); TAKASHI YAMAJI, Ise-shi (JP)

Correspondence Address: YOUNG & THOMPSON, 209 Madison Street, Suite 500, Alexandria, VA, 22314, US

(73) Assignee: MURATEC AUTOMATION CO., LTD., Kyoto-Shi (JP)

(21) Appl. No.: 12/616,934

(22) Filed: Nov. 12, 2009

(30) Foreign Application Priority Data
Nov. 13, 2008 (JP) 2008-291204

(51) Int. Cl. B66C 1/42

(52) U.S. Cl. 294/119.1; 294/86.4

(57) ABSTRACT

A transporting apparatus is provided with a main body part which defines an inner space and an opening in which the inner space is open to an external space and which can accommodate a load from the external space to the inner space through the opening; a holding device which is disposed at a position facing or in contact with the inner space of the main body part and which can hold the accommodated load within the inner space; and one or a plurality of grips which are disposed at positions facing or in contact with the external space of the main body part and which can be grabbed from the external space side.

### BACKGROUND OF THE INVENTION

1. Field of the Invention

The present invention relates to a transporting apparatus for transporting a load (i.e. a transported object or an object) which is a container such as a FOUP (Front Opening Unified Pod) for accommodating or housing various substrates for manufacturing semiconductor devices and the like. Here, the “load” (i.e. the “transported object” or “object”) in the present invention means a product, an intermediate product, a part, an article, a work, a partly-finished good, a good or the like (e.g. a semiconductor or LCD device), or means a box or container for containing such a product or the like (e.g, a container containing the semiconductor or LCD device), which has been transported or is to be transported by the transporting carriage. The load may be a carrier for containing an object to be carried such as a FOUP.

2. Description of the Related Art

As this kind of container, for example, a FOUP which can accommodate a plurality of semiconductor wafers with an aperture of 300 mm is disclosed (refer to Japanese Patent Application Publication Laying Open No. 2007-123673). Specifically, this type of FOUP is used mainly to transport the semiconductor wafers in a plurality of processes along a route or in each process. In order to facilitate the transportation by manpower in the FOUP, for example, a grip (referred to as e.g. a “side flange”) as shown by a referential numeral 3d in FIG. 2 in Japanese Patent Application Publication Laying Open No. 2007-123673 is generally provided on each of the both sides.

According to the container in Japanese Patent Application Publication Laying Open No. 2007-123673, the aperture of the semiconductor wafers to be accommodated is 300 mm; however, the aperture has been recently increased to be more than 300 mm. Along with that, wafer cases are increased in size and in weight, and for example, semiconductor wafers with an aperture 450 mm have been promoted.

This is not generally known, but according to experiments or research results of the present inventors, in case of this aperture size, the size of the wafer case is desirably minimized due to the reservation of a storage space or the like. Thus, not providing the grip is standardized. However, even if the transportation is automated in accordance with a transportation schedule by e.g. a transporting system, the transporting system is immediately stopped due to troubles such as a failure in a traveling device, a collision with an obstacle, and a derailment of a transporting vehicle. In this case, if the grip or the like for carrying the wafer case is not provided in order to move the transporting vehicle from the route or in order to return the moved transporting vehicle to the route, the wafer case possibly falls down by mistake and the semiconductor wafer is possibly damaged, particularly when the wafer case increased in weight is held with bare hands, which is technically problematic.

### SUMMARY OF THE INVENTION

It is therefore an object of the present invention to provide a transporting apparatus that allows a load which is a container such as a wafer case to be removed from a route and transported, relatively easily, with the load miniaturized.

The above object of the present invention can be achieved by a transporting apparatus provided with: a main body part which defines an inner space and an opening in which the inner space is open to an external space and which can accommodate a load from the external space to the inner space through the opening; a holding device which is disposed at a position facing or in contact with the inner space of the main body part and which can hold the accommodated load within the inner space; and one or a plurality of grips which are disposed at positions facing or in contact with the external space of the main body part and which can be grabbed from the external space side.

According to the transporting apparatus of the present invention, the transporting apparatus is an apparatus for accommodating the load, such as a FOUP, and for transporting the accommodated load by manpower. Here, the “load” is transported along a route laid in a factory or the like, by a transporting vehicle such as a vehicle and OHT (Overhead Hoist Transport). On the route, for example, a port is installed for entering and leaving between a stocker and a manufacturing apparatus or the like. For example, during the transportation by the transporting vehicle, the load is stuck on the route due to the failure of the port or the like.

In this case, for example, the one or plurality of grips are grabbed by manpower, such as a manger of the transporting system, and the main body part is displaced to an upper side or a lateral side of the load which exists in the external space and is also displaced toward the load so as to cover the load, thereby accommodating the load in the inner space through the opening. Here, the “main body part” means a case having a surface, or a frame not having a surface or the like. The “inner space” defined by the main body part is a space which can entirely enclose the load and means an inner space of the main body part. On the other hand, the “external space” opposed to the inner space means, for example, an external space of the main body part. The “opening” is an opening in which the inner space is open to the external space and which separates the inner space and the external space, and it has a size which allows the load to be passed between the inner space and the external space. Then, when the load is accommodated in the inner space, for example, the holding device is driven to hold the load and the load is held in the inner space. Here, the “holding device” means a holding mechanism such as a hoist mechanism. The holding device is disposed on the ceiling wall or inner wall opposed to the inner space of the main body part. With the load held in the inner space, the one or plurality of grips are grabbed again by manpower, and the main body part and the load accommodated in the main body part are arbitrarily carried. By this, the load stuck on the route is displaced off the route.

After that, the main body part which accommodates the load is displaced by manpower onto a predetermined shelf placed in a factory or the like. Then, the holding device is driven to release the load, and the load and the main body part are separated.

As described above, the load is displaced to a place where a manager or the like can arbitrarily come and go, by using the transporting apparatus equipped with the grips, without directly installing the grips to the load. Therefore, it is possible to transport the load off the route, with the load miniaturized.

In one aspect of the transporting apparatus of the present invention, the opening is open to at least a lower side, and the main body part is adapted to accommodate the load through the opening from the lower side.

According to this aspect, the opening is open to the lower side of the inner space. For example, if the load is stuck on the route, the main body part is displaced to the upper side of the load which exists in the external space and is also displaced to the lower side toward the load so as to cover the load, by manpower. By this, the load is accommodated in the inner space from the lower side of the inner space through the opening.

In this aspect, the holding device may be provided with: a supporting part which is displaced between a support position for supporting the load and a release position for releasing the load; an operating part which is operated when the supporting part is displaced; and a joint part which is disposed between the operating part and the supporting part and which joints the operating part and the supporting part such that the supporting part is displaced in accordance with an operation of the operating part.

By virtue of such construction, when the load is held by the holding device, the operating part is operated by manpower, with the main body part covering the load. Then, the supporting part is displaced to the support position through the joint part. On the other hand, when the load is released by the holding device, the operating part is operated by manpower. Then, the supporting part is displaced to the release position through the joint part. Here, the “joint part” includes, for example, a series of plurality of gears and means a mechanism for transmitting the power of the driven operating part to the supporting part. Specifically, for example, of the series of plurality of gears, the teeth of the gear on one end may be engaged with the drive shaft of the operating part, and the teeth of the gear on the other end may be engaged with the drive shaft of the supporting part. By constructing the holding device in this manner, it is possible to easily fix or separate the load and the main body part even by manpower. Incidentally, for example, the supporting part may be disposed on the ceiling wall or side wall within the main body part to be held within the main body part (in other words, the inner space). Moreover, for example, the operating part may be disposed on the upper surface or side surface of the main body part to operate from the external side of the main body part by manpower (in other words, the external space side).

In this aspect, the supporting part may support a convex engaging part installed on an upper surface of the load and a concave engaging part disposed in an upper portion of the load.

By virtue of such construction, when the load is held by the holding device, the convex engaging part of the load or the concave engaging part (specifically, for example, a brim portion) is directly supported by the supporting part. Here, the “convex engaging part” means, for example, an outer flange of the FOUP. Specifically, for example, the convex engaging part is a T-shaped projection installed on the upper surface of the FOUP main body which accommodates a semiconductor wafer, and the both ends may be supported by the supporting part from the lower surface side. The “concave engaging part” means, for example, an inner flange of the FOUP. Specifically, for example, the concave engaging part is an inversed T-shaped opening formed in the upper portion of the FOUP main body, and it may be supported by the supporting part being located on the both ends. It is possible to apply the supporting part to the engaging parts in various shapes. In particular, the transporting apparatus including the supporting part applied to the concave engaging part can be miniaturized by the amount of lowering the support position for supporting the concave engaging part, in comparison with the case of the convex engaging part.

In another aspect of the transporting apparatus of the present invention, the opening is open to at least a lateral side, and the main body part is adapted to accommodate the load through the opening from the lateral side.

According to this aspect, the opening is open to the lateral side of the inner space. For example, if the load is stuck on the route, the main body part is displaced to the lateral side of the load which exists in the external space and is also displaced in the horizontal direction toward the load so as to cover the load, by manpower. At this time, if the load is guided by the holding device and is accommodated in the inner space from the lateral side of the inner space through the opening, the load is held in the inner space. Here, the “holding device” means, for example, a suspension mechanism which can suspend the load. Specifically, for example, a suspension part (in other words, the supporting part) of the suspension mechanism may be disposed on the ceiling wall or side wall within the main body part or may be unified with the upper surface of the main body part, so as to be engaged with the engaging part, such as an outer flange or an inner flange, of the load. With the load held in the inner space, the one or plurality of grips are continuously grabbed by manpower, and the main body part and the load accommodated in the main body part are arbitrarily carried. By this, the load stuck on the route is displaced off the route.

As described above, as in the case where the opening is open to the lower side of the inner space, the load is displaced to a place where a manager or the like can arbitrarily come and go, by using the transporting apparatus equipped with the grips, without directly installing the grips to the load. Therefore, as in the case where the opening is open to the lateral side of the inner space, it is possible to transport the load off the route, with the load miniaturized.

In this aspect, the holding device may have a supporting part which supports a convex engaging part installed on an upper surface of the load and a concave engaging part disposed in an upper portion of the load.

By virtue of such construction, when the load is held by the holding device, the convex engaging part of the load or the concave engaging port (specifically, for example, a brim portion) is directly supported by the supporting part. Here, the “supporting part” means a pair of planar members which are fixed on the ceiling wall within the main body part and in which their tip portions are bended inward or outward. Specifically, for example, the aforementioned outer flange or inner flange may be supported by the bended tip portions. The supporting part can be applied to the engaging parts in various shapes. In particular, the holding device such as a suspension mechanism applied when the opening is open to the lateral side of the inner space is conveniently designed because a time for the operation by manpower is saved, and the holding device can be formed at lower cost than a holding device provided with a complicated mechanism, such as the operating part and the joint part described above.

In this aspect, the one or plurality of grips may be installed in each of a plurality of side surfaces corresponding to other plurality of lateral sides which are different from the lateral side in the main body part.

According to this aspect, the one or plurality of grips are installed on two side surfaces each of which is adjacent to the opening if the main body part has a plurality of surfaces. In this case, for example, the one or plurality of grips on the two side surfaces may be grabbed by two managers, and the main body part (in other words, the load within the main body part) may be carried. Moreover, for example, if the one or plurality of grips are installed on one side surface opposed to the opening in addition to the aforementioned two side surfaces, the one or plurality of grips on the three side surfaces may be grabbed by three managers, and the main body part may be carried. As described above, the plurality of grips can be installed on the plurality of surfaces, depending on the weight of the load or the like. Therefore, it is possible to form the transporting apparatus, more conveniently.

In this aspect, the one or plurality of grips may be installed on an upper surface of the main body part in addition to the plurality of side surfaces.

By virtue of such construction, for example, the one or plurality of grips on the upper surface of the main body part may be grabbed by one manager, and the main body part may be carried. By this, for example, if the number of persons such as managers is small, the main body part can be easily displaced even by one person. Therefore, it is possible to form the transporting apparatus, more conveniently.

The nature, utility, and further features of this invention will be more clearly apparent from the following detailed description with reference to preferred embodiments of the invention when read in conjunction with the accompanying drawings briefly described below.

### BRIEF DESCRIPTION OF THE DRAWINGS

FIG. 1 are front views showing a transporting apparatus in a first embodiment;

FIG. 2 are top views showing a holding device in FIG. 1;

FIG. 3 are top views showing a joint part in FIG. 2;

FIG. 4 are front views showing a transporting apparatus in a second embodiment;

FIG. 5 is a front view showing one example of the holding device of the present invention;

FIG. 6 is a front view showing one example of the holding device of the present invention;

FIG. 7 is a perspective view showing one example of the supporting part of the present invention;

FIG. 8 is a perspective view showing one example of the supporting part of the present invention;

FIG. 9 is a perspective view showing a transporting apparatus in a third embodiment;

FIG. 10 is a perspective view showing one example of the holding device of the present invention;

FIG. 11 is a perspective view showing one example of a method of installing grips in the present invention; and

FIG. 12 is a perspective view showing one example of the method of installing the grips in the present invention.

### DETAILED DESCRIPTION OF THE PREFERRED EMBODIMENT

Hereinafter, embodiments of the present invention will be explained with reference to the drawings.

### First Embodiment

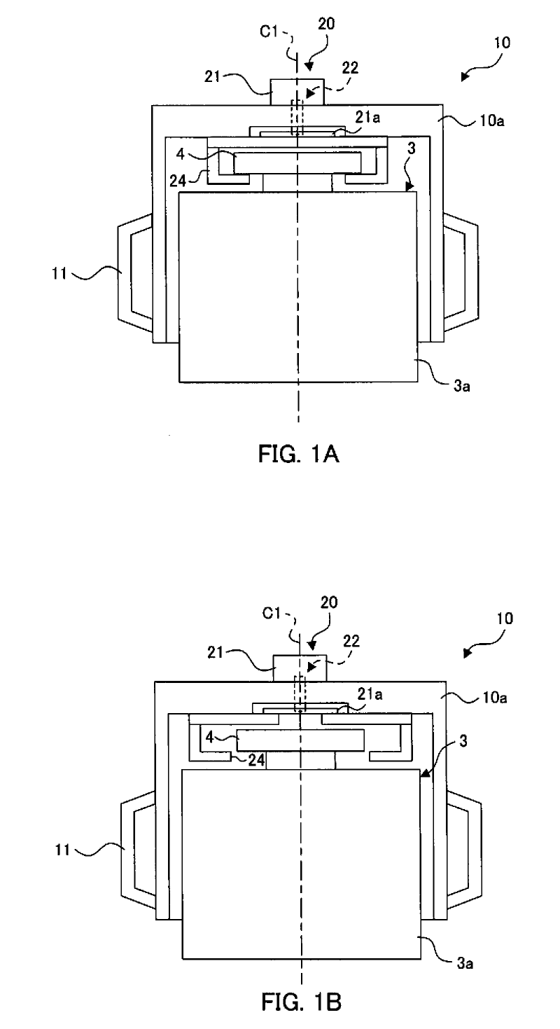

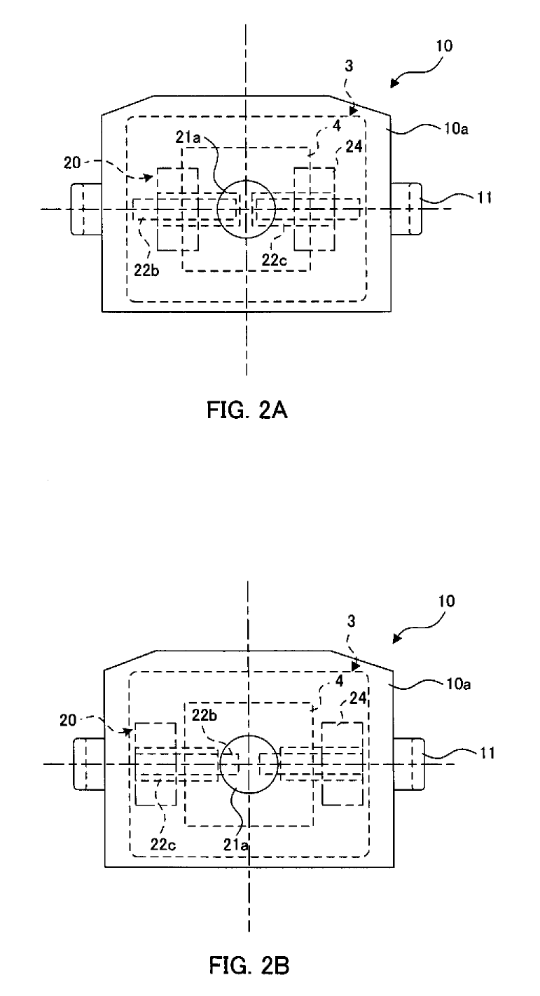

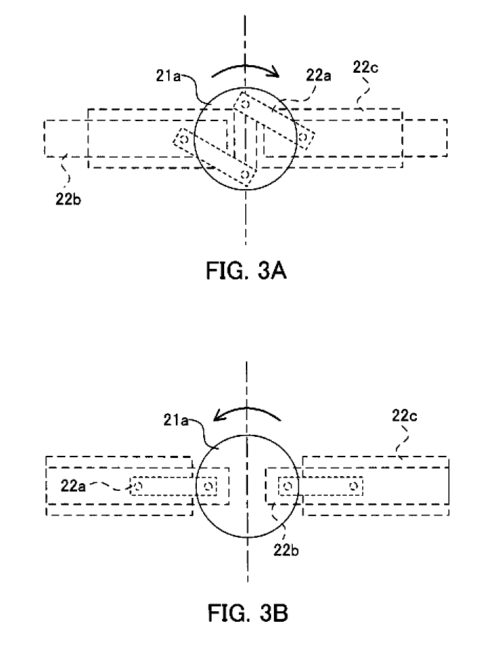

Firstly, the structure of a transporting apparatus in a first embodiment will be explained with reference to FIG. 1 to FIG. 3. FIG. 1 are front views schematically showing a transporting apparatus in a first embodiment. FIG. 2 are top views showing a holding device in FIG. 1 observed from the top side. FIG. 3 are top views particularly showing a joint part in FIG. 2 observed from the top side. Incidentally, FIG. 1A, FIG. 2A, and FIG. 3A show a support position of a supporting part, and FIG. 1B, FIG. 2B, and FIG. 3B show a release position of the supporting part.

In FIG. 1, a transporting apparatus 10 in the embodiment is provided with a main body part 10a, a holding part 20, and grips 11. The transporting apparatus 10 is an apparatus for accommodating a FOUP 3 and displacing the accommodated FOUP 3. The FOUP 3 is provided with a T-shaped flange 4 (i.e. one example of the “convex engaging part” of the present invention) on the upper surface in the embodiment, as one example of the “load” of the present invention.

The main body part 10a is open on the front surface (i.e. the front surface in FIG. 1) and the lower surface of an inner space in which the FOUP 3 is accommodated.

The holding part 20 is adapted to hold the FOUP 3, as one example of the “holding device” of the present invention. The holding part 20 is disposed on the upper surface of the main body part 10a. The holding part 20 is provided with an operation control 21, a joint part 22, and a supporting part 24.

The operation control 21 is rotatably disposed on the upper surface of the main body part 10a, as one example of the “operation part” of the present invention. The operation control 21 is rotated about an axis C1 by a manager of the transportation system. A rotational member 21a is fixed on the tip portion of the rotation axis of the operation control 21.

In FIG. 2, the joint part 22 joints the operation control 21 and the supporting part 24 and moves in tandem with the rotational operation of the operation control 21, thereby displacing the supporting part 24. The joint part 22 is provided with a connection part 22a, a slide guide 22b, and a moving part 22c.

In FIG. 3, the connection part 22a is a pair of hinge members. In each of the pair of hinge members, one fulcrum is connected to the rotational member 21a, and the other fulcrum is connected to the moving part 22c. With regard to the action of the connection part 22a, specifically, when the pair of hinge members are parallel as shown in FIG. 3A and if the rotational member 21a is rotated clockwise by a clockwise rotational operation of the operation control 21, the pair of hinge members are aligned as shown in FIG. 3B. On the other hand, when the pair of hinge members are aligned as shown in FIG. 3B and if the rotational member 21a is rotated counterclockwise by a counterclockwise rotational operation of the operation control 21, the pair of hinge members are parallel as shown in FIG. 3A. By this action, the connection part 22a displaces the moving part 22c in a horizontal direction.

The slide guide 22b is fixed within the main body part 10a. The moving part 22c is a pair of planar members and is adapted to be displaced along the slide guide 22b in accordance with the rotational operation of the operation control 21. With regard to the displacement of the moving part 22c, specifically, when the pair of planar members are extremely close to each other as shown in FIG. 2A and if the rotational member 21a is rotated clockwise, the pair of planar members are far away from each other in the horizontal direction as shown in FIG. 2B. On the other hand, when the pair of planar members are far away from each other in the horizontal direction as shown in FIG. 2B and if the rotational member 21a is rotated counterclockwise, the pair of planar members are extremely close to each other as shown in FIG. 2A. The supporting part 24 is fixed on the lower surface of each of the pair of the planar members.

The supporting part 24 is a pair of supporting members formed symmetrically in the horizontal direction. In each of the pair of supporting members, the tip portion is bended inward. The pair of supporting members are displaced between the support position and the release position in accordance with the rotational operation of the operation control 21. With regard to the displacement of the pair of supporting members, specifically, when the pair of supporting members are located on the lower surface side of both ends of the flange 4 and are in a state of supporting the FOUP 3 (i.e. at the support position) as shown in FIG. 1A and FIG. 2A and if the rotational member 21a is rotated clockwise, the pair of supporting members are located on the lateral side of both ends of the flange 4 and are in a state of releasing the FOUP 3 (i.e. at the release position) as shown in FIG. 1A and FIG. 2B. On the other hand, when the pair of supporting members are located on the lateral side of both ends of the flange 4 and are in the state of releasing the FOUP 3 as shown in FIG. 1A and FIG. 2B and if the rotational member 21a is rotated counterclockwise, the pair of supporting members are located on the lower surface side of both ends of the flange 4 and are in the state of supporting the FOUP 3 as shown in FIG. 1A and FIG. 2A.

Each of the grips 11 is installed on the two side surfaces of the main body part 10a (i.e. on the right and left sides in FIG. 1) such that it can be grabbed from an external space of the main body part 10a. The grips 11 are normally grabbed by the manager of the transportation system when the main body part 10a (i.e. the FOUP 3 held by the holding part 20) is displaced.

Next, with reference to FIG. 1 and FIG. 2, an explanation will be given on an operation of displacing the FOUP 3 stuck on a not-illustrated route, off the route by using the transporting apparatus 10 in the embodiment.

In the transportation system, if the FOUP 3 stuck on the route is detected, the grips 11 of the transporting apparatus 10 which does not accommodate the FOUP 3 are firstly grabbed by at least one manager, and the main body part 10a is displaced to above the stuck FOUP 3. Then, the main body part 10a is displaced to a lower side or downward such that the FOUP 3 is accommodated within the main body part 10a. At this time, the supporting part 24 is displaced to the release position.

Then, as the operation control 21 is rotated clockwise by the one manager, the supporting part 24 is displaced to the support position. By this displacement, the flange 4 of the FOUP 3 is fixed on the main body part 10a. Then, the grips 11 are grabbed by at least one manager, and the main body part 10a which holds the FOUP 3 is displaced off the route.

Incidentally, when the FOUP 3 is removed from the main body part 10a displaced off the route, as the operation control 21 is rotated counterclockwise, the supporting part 24 is displaced to the release position. By this displacement, the flange 4 is released from the main body part 10a, and the FOUP 3 is removed from the transporting apparatus 10.

As described above, according to the operation in the first embodiment, the FOUP 3 is displaced to a place where at least one manager can arbitrarily come and go, by using the transporting apparatus 10 equipped with the grips 11, without directly installing the grips 11 to the FOUP 3. Therefore, it is possible to transport the FOUP 3 off the route, with the FOUP 3 miniaturized.

Incidentally, in the operation in the first embodiment, the FOUP 3 equipped with the flange 4 on the upper surface is displaced; however, it is also possible to displace the FOUP in another form by partially changing the structure of the holding part 20.

### Second Embodiment

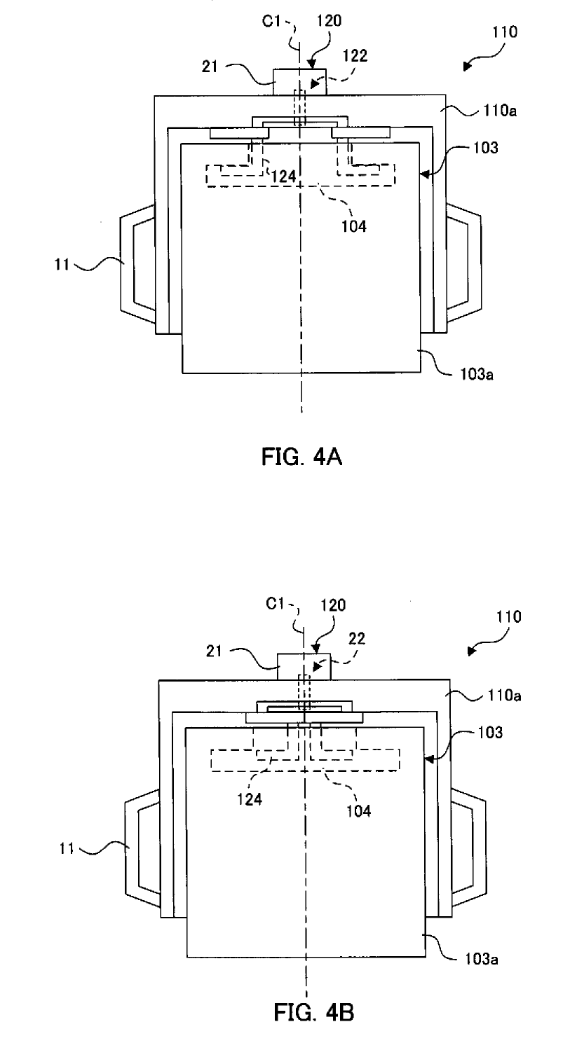

Next, with reference to FIG. 4, an explanation will be given on the structure of a transporting apparatus in a second embodiment. FIG. 4 are front views schematically showing the transporting apparatus in the second embodiment. Incidentally, FIG. 4A shows a support position of a supporting part in the second embodiment, and FIG. 4B shows a release position of the supporting part. Moreover, in the second embodiment, portions which are formed substantially as in the transporting apparatus 10 in the first embodiment will carry the same referential numerals as in the transporting apparatus 10 in the first embodiment, and the explanation thereof will be omitted.

In FIG. 4, in the embodiment, the aspect of a FOUP 103 is different from the FOUP 3 in FIG. 1. In response to this, in a transporting apparatus 110 in the embodiment, the aspect of a holding part 120 is different in comparison with the transporting apparatus 10 in FIG. 1.

The FOUP 103 has an inverted T-shaped engaging part 104 (i.e. one example of the “concave engaging part” of the present invention) in the upper part of the FOUP 3, instead of the flange 4 in FIG. 1.

The holding part 120 is disposed on the upper surface of a main body part 110a, as in the holding part 20 in FIG. 1. The holding part 120 is provided with an operation control 121, a joint part 122, and a supporting part 124. With regard to the joint part 122, only the shape is different from the joint part 22 in FIG. 1.

The supporting part 124 has a different shape from that of the supporting part 24 in FIG. 1. The supporting part 124 is a pair of supporting members, and the tip portion is bended outward in each of the pair of supporting members. With regard to the displacement of the pair of supporting members, specifically, when the pair of supporting members are separated horizontally and located on the both ends of the engaging part 104 to support the FOUP 103 as shown in FIG. 4A and if the operation control 21 is rotated clockwise, the pair of supporting members are brought closer and located in the central portion of the engaging part 104 and are in the state of releasing the FOUP 3 (i.e. at the release position) as shown in FIG. 4B. On the other hand, when the pair of supporting members are located in the central portion of the engaging part 104 and are in the state of releasing the FOUP 3 as shown in FIG. 4B and if the operation control 21 is rotated counterclockwise, the pair of supporting members are located on the both ends of the engaging part 104 to support the FOUP 103 as shown in FIG. 4A.

Next, with reference to FIG. 4, an explanation will be given on an operation of displacing the FOUP 103 stuck on the route, off the route by using the transporting apparatus 110 in the embodiment.

In the transportation system, if the FOUP 103 stuck on the route is detected, the grips 11 of the transporting apparatus 110 are firstly grabbed by at least one manager, and the main body part 110a is displaced to accommodate the FOUP 103 inside, as in the operation in the first embodiment. Then, as the operation control 21 is rotated clockwise by the one manager, the engaging part 104 of the FOUP 103 is fixed to the main part body 110a. Then, the grips 11 are grabbed by at least one manager, and the main body part 110a which holds the FOUP 103 is displaced off the route.

Incidentally, when the FOUP 103 is removed from the main body part 110a displaced off the route, as the operation control 21 is rotated counterclockwise, the engaging part 104 is released from the main body part 110a, and the FOUP 103 is removed from the transporting apparatus 110.

As described above, even by the operation in the second embodiment, the FOUP 103 is displaced to a place where at least one manager can arbitrarily come and go, by using the transporting apparatus 110 equipped with the grips 11, without directly installing the grips 11 to the FOUP 103. Therefore, it is possible to transport the FOUP 103 off the route, with the FOUP 103 miniaturized. Moreover, the FOUP 3 having a concave engaging part 104 instead of the convex flange can be further miniaturized.

Incidentally, the first embodiment and the second embodiment apply the holding parts 20 and 120 provided with the supporting parts 24 and 124 which displace the support position and the release position in the horizontal direction, respectively; however, the present invention is not limited to such a holding device.

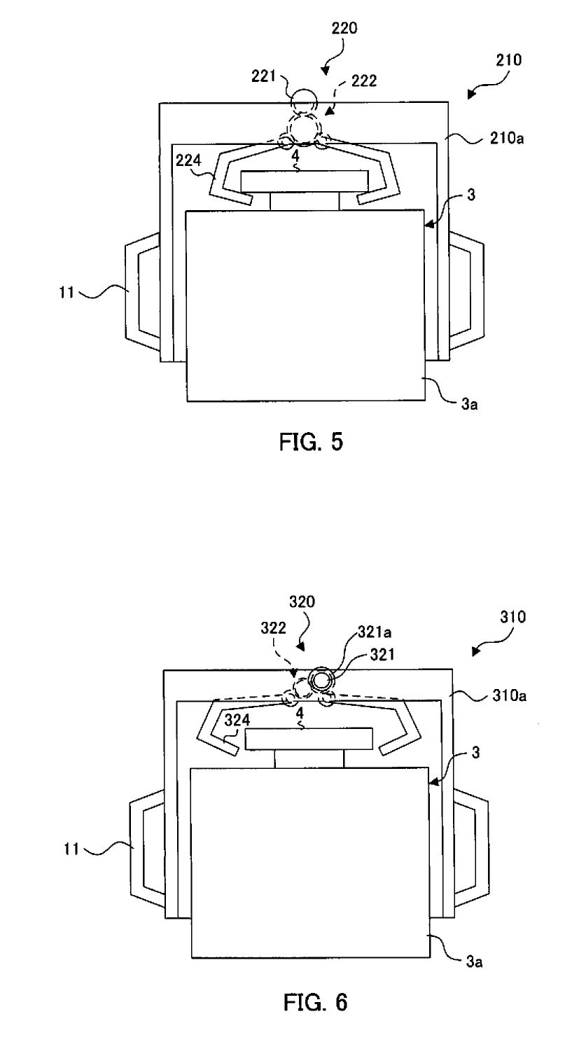

FIG. 5 and FIG. 6 are front views schematically showing one example of the holding device of the present invention, as another example of the holding parts 20 and 120 in FIG. 1 and FIG. 4 described above.

In FIG. 5, a holding part 220 is provided with an operation roller 221, a joint part 222, and a supporting part 224. The operation roller 221 is a rotating member and is rotatably disposed on the upper surface of a main body part 210a. The operation roller 221 is rotated by the manager to trace an outer circumferential surface in the horizontal direction. The joint part 222 is engaged with the rotary teeth of the rotation roller 221. The joint part 222 is formed of a series of three gears and is rotated by the rotational operation of the operation roller 221 to displace the supporting part 224. The supporting part 224 is a pair of supporting members formed symmetrically in the horizontal direction. The supporting part 224 is displaced to draw an arc between the support position and the release position, in accordance with the operation of the operation roller 221.

In FIG. 6, a holding part 320 is provided with an operation control 321, a joint part 322, and a supporting part 324. The operation control 321 is rotatably disposed in the upper portion on one side surface on which a main body part 310a is open. The operation control 321 is rotated by the manager in an arrow direction. A rotating member 321a is fixed on the tip portion of a not-illustrated rotation axis of the operation control 321. The joint part 322 is engaged with the rotary teeth of the rotating member 321a. The joint part 322 is formed of a series of three gears and is rotated by the rotational operation of the operation control 321 to displace the supporting part 324. The supporting part 324 is a pair of supporting members formed symmetrically in the horizontal direction, as in the supporting part 224 in FIG. 5. The supporting part 324 is displaced to draw an arc between the support position and the release position, in accordance with the operation of the operation control 321.

As described above, the aforementioned holding devices 220 and 320 move the supporting parts 224 and 324 through the joint parts 222 and 322 which are a series of the plurality of gears, in tandem with the rotational operation by the operation roller 222 or the operation control 321, respectively.

Incidentally, the first embodiment and the second embodiment apply the supporting parts 24 and 124 for simply supporting the flange 4 or the engaging part 104, respectively; however, the present invention is not limited to such a supporting part.

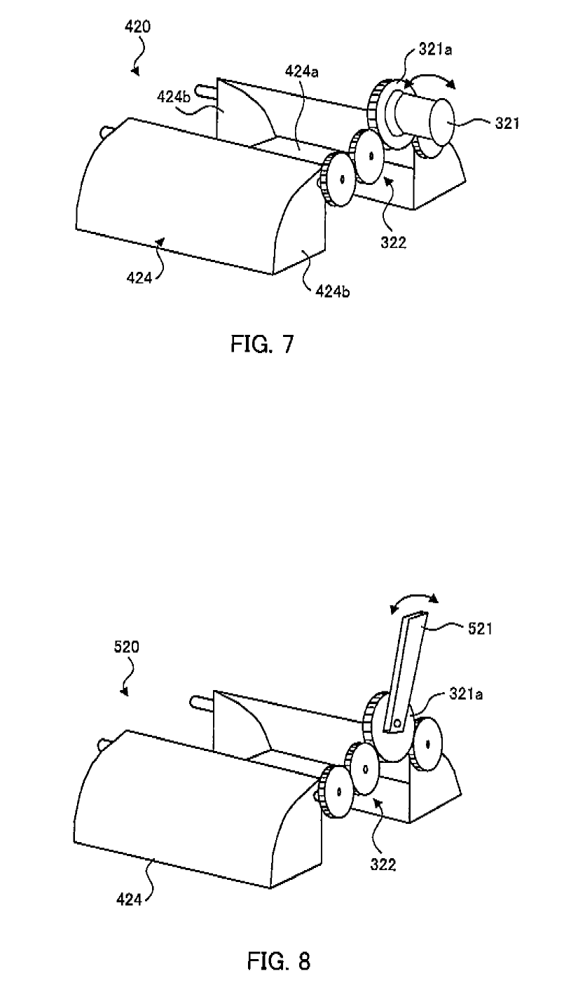

FIG. 7 is a perspective view showing one example of the supporting part of the present invention, as another example of the supporting part 324 in FIG. 6. In FIG. 7, a supporting part 424 is a pair of supporting members. Each of the pair of supporting members is provided with not only a supporting surface 424a for supporting the flange 4 of the FOUP 3 from the lower surface side but also two side surfaces 424b each of which is adjacent to the supporting surface 424a. The two side surfaces 424b function such that the flange 4 to be supported is held at a predetermined position and function such that the flange 4 held inside does not slide from the inside of the main body part when the main body part is carried by the manager. In other words, it is certain that the flange 4 is fixed by the two side surfaces 424b, so that it is possible to stably transport the FOUP 3.

Incidentally, the first embodiment and the second embodiment, and FIG. 5 and FIG. 6 apply the operation controls 21 and 321 or the operation roller 221 to be rotated; however, the present invention is not limited such an operation part.

FIG. 8 is a perspective view showing one example of the supporting part of the present invention, as another example of the operation control 321 in FIG. 6. In FIG. 8, an operation lever 521 is an operating device to replace the operation control 321 in FIG. 6 and is rotated by the manger in an arrow direction. A rotating member 321a is fixed to the fulcrum of the operation lever 521.

### Third Embodiment

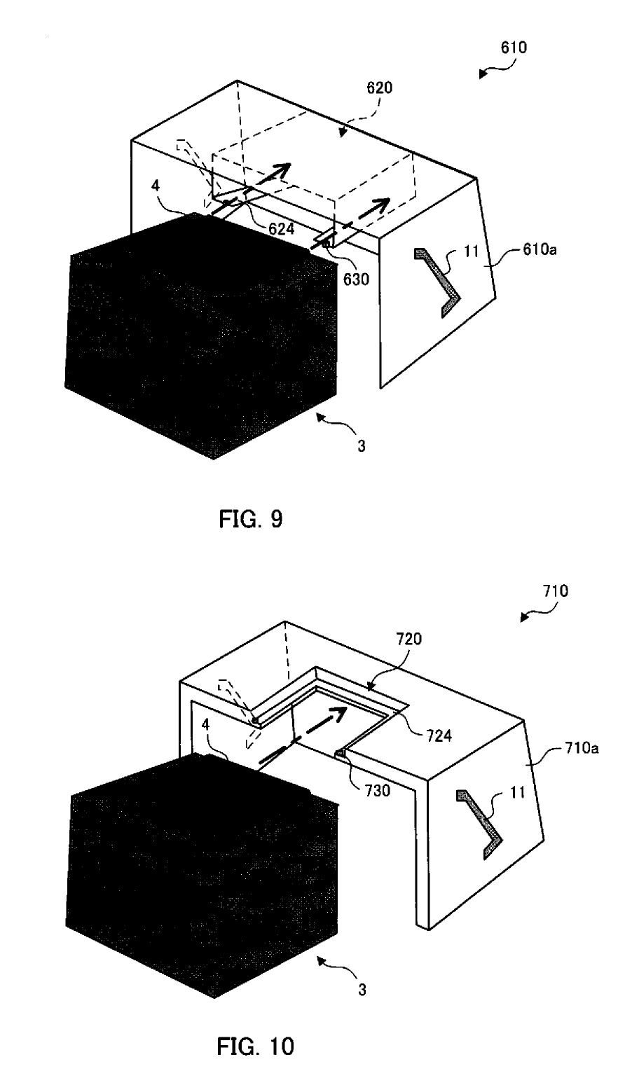

Next, with reference to FIG. 9, an explanation will be given on the structure of a transporting apparatus in a third embodiment. FIG. 9 is a perspective view showing the transporting apparatus in the third embodiment. Incidentally, in the third embodiment, portions which are formed substantially as in the transporting apparatuses 10 and 110 in the first and second embodiments will carry the same referential numerals as in the transporting apparatuses 10 and 110, and the explanation thereof will be omitted.

In FIG. 9, in the embodiment, the aspect of a holding part 620 is different in comparison with the transporting apparatuses 10 and 110 in FIG. 1 and FIG. 4. In the embodiment, at least a front surface (i.e. a surface opposed to the FOUP 3 in FIG. 9) is open in a main body part 610a. In the embodiment, the applied FOUP 3 is the same as in the first embodiment, and it is provided with the flange 4 on the upper surface.

The holding part 620 is disposed on a ceiling wall within the main body part 610a, and it is provided with a supporting part 624 and a stopper 630. The supporting part 624 is a pair of supporting members in which the tip portions are bended inward, as in the supporting part 24 in FIG. 1; however, as opposed to the supporting part 24 in FIG. 1, the supporting part 624 is unified with the main body part 610a without being displaced. The pair of supporting members mutually keep an interval corresponding to the both ends of the flange 4 and have a thickness to be inserted in the horizontal direction between the FOUP 3 main body and the both ends of the flange 4. Moreover, the pair of supporting members have a depth at least corresponding to the flange 4 such that the FOUP 3 is guided to a predetermined holding position within the main body part 610a. In each of the pair of supporting members, a stopper 630 is installed on the side of the front surface of the main body part 610a (i.e. the surface opposed to the FOUP 3 in FIG. 9). The stopper 630 functions to prevent the FOUP 3 held at the predetermined holding position from falling to the front surface side when the main body part 610a is lifted up and carried by the manger. Incidentally, in the embodiment, the thickness of the pair of supporting members is set such that the both ends of the flange 4 can pass over the stoppers 630.

Next, an explanation will be given on an operation of displacing the FOUP 3 by using the transporting apparatus 610 in the embodiment.

Firstly, the grips 11 of the transporting apparatus 610 are grabbed by at least one manager, and the main body part 610a is displaced to the side of the FOUP 3. At this time, the front surface of the main body part 610a (i.e. the surface opposed to the FOUP 3 in FIG. 9) is opposed to the FOUP 3. Then, the main body part 610a is displaced in the horizontal direction toward the FOUP 3 such that the FOUP 3 is accommodated within the main body part 610a. At this time, the main body part 610a is displaced at a height in which the pair of supporting members (i.e. the supporting part 624) are inserted under the both ends of the flange 4 and until the front surface of the FOUP 3 (i.e. a surface opposed to the main body part 610a in FIG. 9) abuts on the wall surface within the main body part 610a. If the rear surface of the FOUP 3 is horizontally displaced to be located inner than or behind the stopper 630 by the horizontal displacement, the FOUP 3 is held at the predetermined holding position within the main body part 610a. Then, the grips 11 are grabbed by at least one manager, and the main body part 610a which holds the FOUP 3 is displaced.

Incidentally, when the FOUP 3 is removed from the displaced main body part 610a, the FOUP 3 is displaced such that the main body part 610a is away from the FOUP 3, with the FOUP 3 grounded. At this time, the main body part 610a is displaced at a height which allows the pair of supporting members to pass between the FOUP 3 main body and the both ends of the flange 4. If the front surface of the FOUP 3 is horizontally displaced to be located outer than or in front of the stopper 630 by the horizontal displacement, the FOUP 4 is released from the main body part 610a, and the FOUP 3 is removed from the transporting apparatus 610.

As described above, according to the operation in the third embodiment, the FOUP 3 is displaced to a place where at least one manager can arbitrarily come and go, by using the transporting apparatus 610 equipped with the grips 11, without directly installing the grips 11 to the FOUP 3, as in the first and second embodiments. Therefore, it is possible to transport the FOUP 3 off the route, with the FOUP 3 miniaturized. In particular, the holding part 620 is conveniently designed because a time for the operation of displacing the supporting part 624 is saved, and the holding part 620 can be formed at low cost because there is no need to have a complicated mechanism.

Incidentally, in the operation in the third embodiment, the holding part 620 is disposed within the main body part; however, the present invention is not limited to such a holding device.

FIG. 10 is a perspective view showing one example of the holding device of the present invention, as another example of the aforementioned holding part 620 in FIG. 9.

In FIG. 10, the applied FOUP 3 is the same as in the first and third embodiments, and it is provided with the flange 4 on the upper surface. In a main body part 710a, the central portion of the upper surface is open. The open portion has a length obtained by adding a slight margin or play to the length in the width direction of a connection part 4a which connects the flange 4 to the FOUP 3 main body (i.e. in a direction of passing the both ends of the flange 4) in width, and the open portion has a length of the depth of the flange 4 (i.e. in a direction perpendicular to the width direction) in depth.

A holding part 720 is unified with the upper surface of the main body part 710a, and it is provided with a supporting part 724 and a stopper 730. The supporting part 724 is an engaging part formed at a lower level than the upper surface along an open portion of the upper surface. The engaging part has a thickness to be inserted in the horizontal direction between the FOUP 3 main body and the both ends of the flange 4. Moreover, the engaging part has a depth at least corresponding to the flange 4 such that the FOUP 3 is guided to a predetermined holding position within the main body part 710a when the FOUP 3 is held. In the engaging part, the stopper 730 is installed on the side of the front surface of the main body part 710a (i.e. a surface opposed to the FOUP 3 in FIG. 10), as in the third embodiment.

As described above, the aforementioned holding part 720 is conveniently designed because a time for the operation of displacing the supporting part 724 is saved, and the holding part 720 can be formed at low cost because there is no need to have a complicated mechanism (i.e. the aforementioned operation control or operation roller, the joint part, and the like), as in the holding part 620 in FIG. 9.

Incidentally, the holding part 620 in the third embodiment and the aforementioned holding part 720 hold the FOUP 3 equipped with the flange 4, and they may be also constructed to hold the holding part 103 equipped with the inversed T-shaped engaging part 104.

Incidentally, in all the aforementioned embodiments, the grips 11 are installed on the respective two side surfaces opposed to each other; however, the present invention is not limited to such installment.

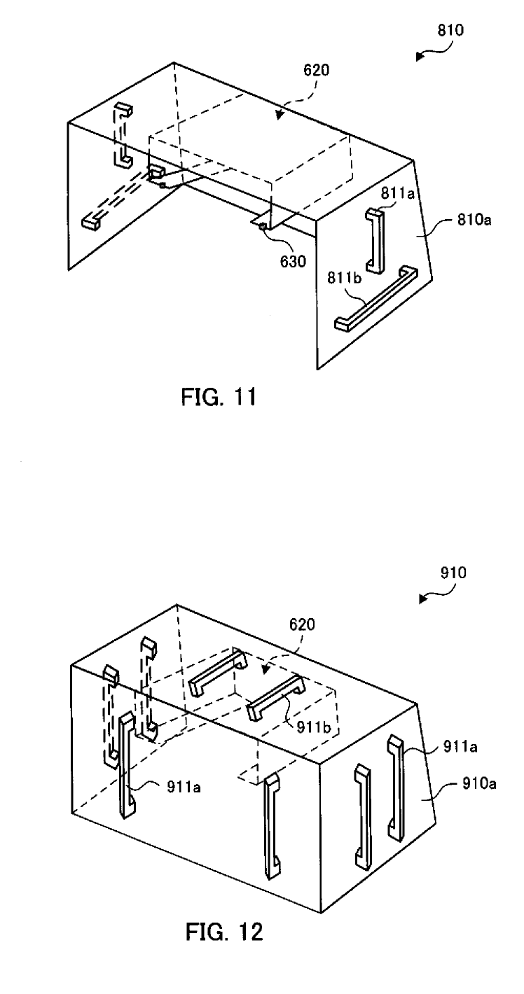

FIG. 11 is a perspective view showing one example of a method of installing grips in the present invention, as another example of the method of installing the grips 11 in FIG. 9. In FIG. 11, in each of the two side surfaces adjacent to the front surface of a main body part 810a, a first grip 811a and a second grip 811b are installed. The first grip 811a is formed to be relatively short, and it is installed such that the longitudinal direction is a perpendicular direction. The second grip 811b is formed to be relatively long, and it is installed such that the longitudinal direction is a horizontal direction.

FIG. 12 is a perspective view showing one example of a method of installing grips in the present invention, as another example of the method of installing the grips 11 in FIG. 9. In FIG. 12, in each of the two side surfaces adjacent to the front surface of a main body part 910a and the rear surface of the main body part 910a, two third grips 911a are installed. Moreover, on the upper surface of the main body part 910a, two fourth grips 911b are installed. The fourth grip 911 is formed to be relatively short, and it is installed such that the longitudinal direction is a horizontal direction.

As described above, two or more grips can be installed on each side surface in mutually different directions, so that it is possible to adjust the number of persons who carry the main body part, depending on the weight of the FOUP 3 to be held. In particular, even if the FOUP 3 increases in weight, that can be responded, so that it is extremely useful in practice. Moreover, if the grips are installed on the upper surface, the main body part can be easily carried even by one person.

The invention may be embodied in other specific forms without departing from the spirit or essential characteristics thereof. The present embodiments are therefore to be regarded in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2008-291204 filed on Nov. 13, 2008 including the specification, claims, drawings and summary is incorporated herein by reference in its entirety.

What is claimed is:

1. A transporting apparatus comprising:
a main body part which defines an inner space and an opening in which the inner space is open to an external space and which can accommodate a load from the external space to the inner space through the opening;
a holding device which is disposed at a position facing or in contact with the inner space of the main body part and which can hold the accommodated load within the inner space; and
one or a plurality of grips which are disposed at positions facing or in contact with the external space of the main body part and which can be grabbed from the external space side.

2. The transporting apparatus according to claim 1, wherein
the opening is open to at least a lower side, and
the main body part is adapted to accommodate the load through the opening from the lower side.

3. The transporting apparatus according to claim 2, wherein the holding device comprises:
a supporting part which is displaced between a support position for supporting the load and a release position for releasing the load;
an operating part which is operated when the supporting part is displaced; and
a joint part which is disposed between the operating part and the supporting part and which joints the operating part and the supporting part such that the supporting part is displaced in accordance with an operation of the operating part.

4. The transporting apparatus according to claim 3, wherein the supporting part supports a convex engaging part installed on an upper surface of the load and a concave engaging part disposed in an upper portion of the load.

5. The transporting apparatus according to claim 1, wherein
the opening is open to at least a lateral side, and
the main body part is adapted to accommodate the load through the opening from the lateral side.

6. The transporting apparatus according to claim 5, wherein the holding device has a supporting part which supports a convex engaging part installed on an upper surface of the load and a concave engaging part disposed in an upper portion of the load.

7. The transporting apparatus according to claim 5, wherein the one or plurality of grips are installed in each of a plurality of side surfaces corresponding to other plurality of lateral sides which are different from the lateral side in the main body part.

8. The transporting apparatus according to claim 7, wherein the one or plurality of grips are installed on an upper surface of the main body part in addition to the plurality of side surfaces.
